(19) United States
(12) Patent Application Publication
(10) Pub. No.: US 2006/0038419 A1
(43) Pub. Date: Feb. 23, 2006

(54) Mounting plate for an auxiliary lock mechanism

(76) Inventor: Ching-Sung Lee, Kaohsiung Hsien (TW)

Correspondence Address: BIRCH STEWART KOLASCH & BIRCH, PO BOX 747, FALLS CHURCH, VA, 22040-0747, US

(21) Appl. No.: 10/919,275

(22) Filed: Aug. 17, 2004

(51) Int. Cl. E05B 15/02

(52) U.S. Cl. 292/357

(57) ABSTRACT

A mounting plate for an auxiliary lock mechanism includes at least one assembling hole and at least one adapter combined therewith. The assembling hole has a neck portion and the adapter correspondingly has a slit adapted to snap-connect to the neck portion of the assembling hole. An engaging length of the adapter is permitted adjusting to extend into a through hole of a latch unit for positioning purpose. In addition, a shorter screw member is selectively connected the adapter with the mounting plate.

### BACKGROUND OF THE INVENTION

1. Field of the Invention

The present invention relates to a mounting plate for an auxiliary lock mechanism. More particularly, the present invention relates to a mounting plate having a pair of assembling holes for combing with an escutcheon rose and a latch unit.

2. Description of the Related Art

Taiwanese Patent Publication No. 271,184, entitled “Main Body Device for a Single Side Auxiliary Lock Mechanism,” discloses a mounting plate, an escutcheon rose, two first screw pins and at least two screw pins. The mounting plate includes an engaging protrusion, an aperture, two first screw holes and at least two second screw holes. The engaging protrusion of the mounting plate is located at a center portion and engaged with an edge of an assembling bore of a doorplate.

In installing operation, the aperture and the two first screw holes of the mounting plate are commonly aligned with a crank hole and two through holes of a conventional latch unit respectively. The two second screw holes of the mounting plate are disposed on an outer periphery thereof. The escutcheon rose has a turn button connected to a crank for a rotational operation. The crank is successively extended through the aperture of the mounting plate and the crank hole of the latch unit. The escutcheon rose has two screw holes at either side of the turn button to align with the first screw holes of the mounting plate.

To mount the mounting plate on the doorplate, two second screws extend through the second screw holes disposed on the outer periphery of the mounting plate and screw-connect to the doorplate. The crank of the escutcheon rose is initially extended through the aperture of the mounting plate and then inserted into the crank hole of the latch unit. To mount the escutcheon rose on the doorplate, two first screws successively extend through the screw holes of the escutcheon rose and the first screw holes of the mounting plate.

However, the escutcheon rose and the mounting plate are able to securely mount the latch unit to the assembling bore of the doorplate by means of screw-connection. Generally, the assembling bore of the doorplate is dimensioned for two standard sizes including 38 mm and 54 mm. For a single size of the mounting plate, the engaging protrusion, in use, is unable to apply to two standard sizes of the assembling bore of the doorplate. To solve this problem in use, it is well known in the art to manufacture two standard sizes of the mounting plate that may increase total manufacture cost. Accordingly, there is a need for manufacturing the mounting plate of the latch unit for two standard sizes of the assembling bore of the doorplate.

To this end, Taiwanese Patent Application No. 93204568, entitled “Mounting Plate Device for an Auxiliary Lock Mechanism,” discloses a single mounting plate including a first engaging protrusion and a second engaging protrusion arranged on either side surface thereof. In assembling operation, a user can select one of the first engaging protrusion or the second engaging protrusion of the mounting plate to insure the correct assembly according to the sizes of the assembling bore of the doorplate. Hence, the single mounting plate is suitable for two standard sizes of the assembling bore of the doorplate that may simplify entire assembling operation and reduce total manufacture cost.

However, the single mounting plate disclosed in TWN No. 93204568 must further include two screw holes provided with female-threaded portion therein. Screw bolts have two different lengths along a longitudinal direction of the mounting plate for connecting between the mounting plate and the latch unit according to two different assembling distances. A longer time is necessary for the relatively longer length of the screw bolt fastened on the screw hole of the mounting plate when the escutcheon rose, the mounting plate and the latch unit are assembled. In addition, a male-threaded portion of the longer length of the screw bolt must be closely fitted for the female-threaded portion of the screw hole of the mounting plate while an end of the screw bolt engaging with the through hole of the latch unit. Consequently, it is inconvenient for along time of assembling operation of the mounting plate.

The present invention intends to provide a mounting plate for an auxiliary lock mechanism having a pair of assembling holes each of which adapted to combine with an adapter with a single length. For positioning purpose an engaging length of the adapter is adjusted to insert into a through hole of a latch unit when the adapter is combined with the mounting plate. Thereby, the single length of the adapter is fastened with a shorter screw that may simplify entire assembling operation and reduce operational time of the mounting plate in such a way to mitigate and overcome the above problem.

### SUMMARY OF THE INVENTION

The primary objective of this invention is to provide a mounting plate for an auxiliary lock mechanism having a pair of assembling holes each of which combined with a single length of an adapter. For saving operational time the adapter may adopt a shorter length so that an engaging length of the adapter is permitted adjusting to extend into a through hole of a latch unit. In addition, the adapter is selectively fastened with a shorter screw member.

The mounting plate in accordance with the present invention includes at least one assembling hole and at least one adapter combined therewith. The assembling hole has a neck portion and the adapter correspondingly has a slit adapted to snap-connect to the neck portion of the assembling hole. An engaging length of the adapter is permitted adjusting to extend into a through hole of a latch unit for positioning purpose. In addition, a shorter screw member is selectively connected the adapter with the mounting plate.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings wherein:

FIG. 1 is a perspective view of an auxiliary lock mechanism and a doorplate in accordance with a preferred embodiment of the present invention;

FIG. 2 is an assembled elevational view of the auxiliary lock mechanism in accordance with the preferred embodiment of the present invention;

FIG. 3 is an assembled elevational view, similar to FIG. 2, of the auxiliary lock mechanism in accordance with the preferred embodiment of the present invention;

FIG. 4 is a cross-sectional view, taken along line 4-4 in FIG. 3, of the auxiliary lock mechanism assembled on the doorplate in accordance with the preferred embodiment of the present invention; and

FIG. 5 a cross-sectional view, similar to FIG. 4, of the auxiliary lock mechanism assembled on the doorplate in accordance with the preferred embodiment of the present invention.

### DETAILED DESCRIPTION OF THE INVENTION

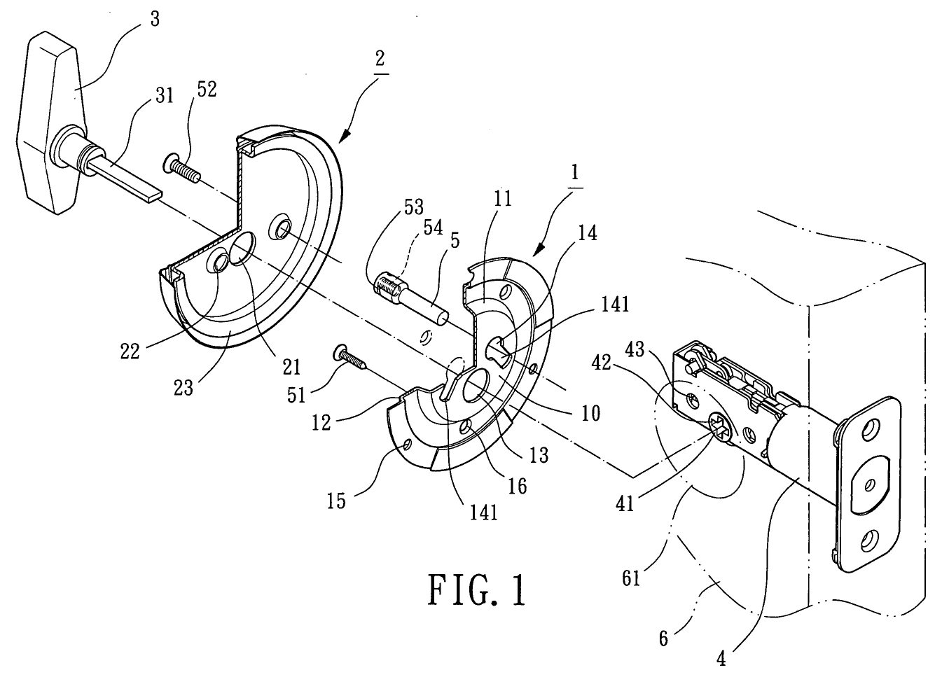

Referring initially to FIG. 1, it depicts an auxiliary lock mechanism in accordance with a preferred embodiment of the present invention. In this preferred embodiment, the auxiliary lock mechanism generally includes a mounting plate 1, an escutcheon rose 2, a turn button 3 and a latch unit 4.

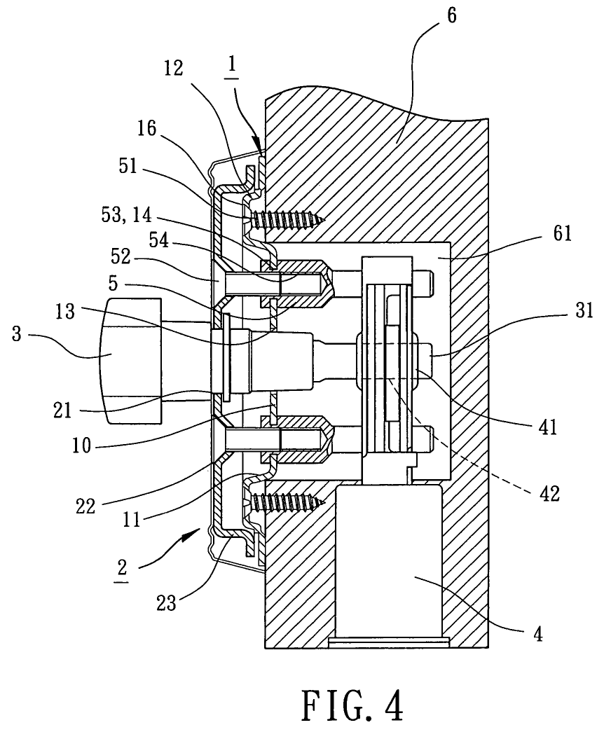

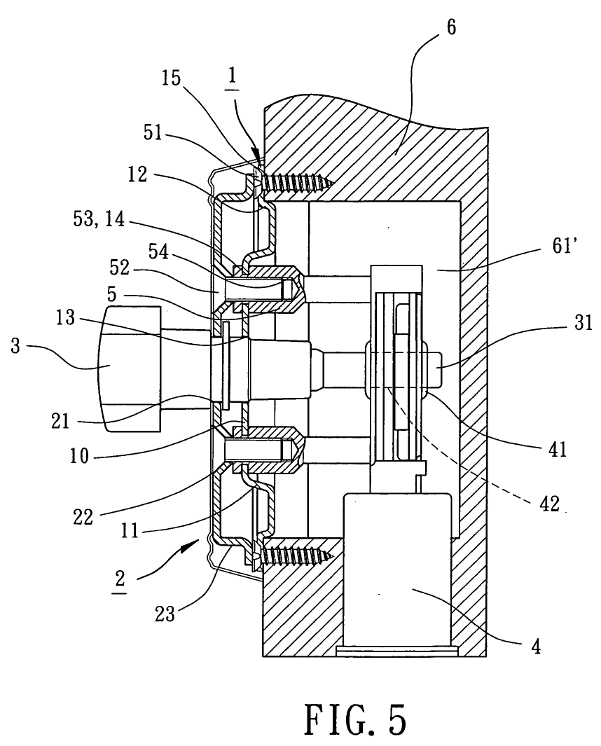

Turning now to FIGS. 1 through 5, the construction of the mounting plate 1 shall be described in detail. The mounting plate 1 is a one-piece disc punched in a metal sheet. Basically, the mounting plate 1 includes a first engaging protrusion 11, a second engaging protrusion 12, a lock core aperture 13, at least two assembling holes 14, at least two first connecting holes 15 and at least two second connecting holes 16. The mounting plate 1 is punched to coaxially form the first engaging protrusion 11 and the second engaging protrusion 12. Accordingly, the first engaging protrusion 11 bulges on a first side surface of the mounting plate 1 while the second engaging protrusion 12 bulging on a second side surface of the mounting plate 1. Preferably, the first engaging protrusion 11 has a relatively smaller diameter of 38 mm correspondingly applied to an assembling bore 61 of a doorplate 6, as best shown in FIG. 4. Alternatively, the second engaging protrusion 12 has a relatively larger diameter of 54 mm correspondingly applied to an assembling bore 61′ of a doorplate 6, as best shown in FIG. 5. The lock core aperture 13 and the assembling holes 14 are arranged in an inner flat surface 10 confined within the first engaging protrusion 11. Preferably, the assembling hole 14 is elongated and formed with a non-circular hole. In this preferred embodiment, a distal end of the assembling hole 14 extends to form a neck portion 141. The two neck portions 141 of the assembling holes 14 are symmetrical with respect to a centerline and extended along two oblique lines. The assembling hole 14 of the mounting plate 1 is adapted to combine with an adapter 5 which has a pair of slits 53 and a screw hole 54. In assembling operation, the slits 53 of the adapter 5 are secured to the neck portion 141 of the assembling hole 14, and the screw hole 54 of the adapter 5 is screw-connected with a screw member 52 so as to mount the escutcheon rose 2.

Still referring to FIGS. 1 through 5, the first connecting holes 15 of the mounting plate 1 are arranged on an outermost edge to receive screws 51 for connecting the mounting plate 1 to a periphery of the assembling bore 61′, as best shown in FIG. 5. Alternatively, the second connecting holes 16 of the mounting plate 1 are arranged on the second engaging protrusion 12 to receive the screws 51 for connecting the mounting plate 1 to a periphery of the assembling bore 61, as best shown in FIG. 4.

Referring again to FIGS. 1 and 4, the construction of the escutcheon rose 2 shall be described in detail. The escutcheon rose 2 is applied to cover the auxiliary lock mechanism. Basically, the escutcheon rose 2 includes a lock core aperture 21, at least two assembling holes 22 and a reinforcing plate 23. The lock core aperture 21 and the two assembling holes 22 of the escutcheon rose 2 are corresponding to the lock core aperture 13 and the two assembling holes 14 of the mounting plate 1. In installing operation, the screw members 52 successively extend through the assembling holes 22 and 14 to combine the escutcheon rose 2 with the mounting plate 1. Preferably, the reinforcing plate 23 is made of a thick metal plate that is relatively rigid and strong to withstand normal usage of the lock mechanism. In order to reinforce the structure of the escutcheon rose 2, the reinforcing plate 23 is inserted into or fixed to the inner space of the escutcheon rose 2.

Still referring to FIGS. 1 and 4, the constructions of the turn button 3 and the latch unit 4 are shall be described in detail. The turn button 3 has a spindle 31 successively extending through the lock core apertures 21 and 13 and then into the assembling bore 61 of the doorplate 6. The latch unit 4 is conventional and installed in the assembling bore 61 of the doorplate 6. Typically, the latch unit 4 includes an actuating cam 41 and an actuating hole 42 thereof. In assembling, the spindle 31 of the turn button 3 is inserted into the actuating hole 42 of the latch unit 4 so that the turn button 3 is able to operate the latch unit 4 to constitute the auxiliary lock mechanism.

Still referring to FIGS, 4 and 5, the construction of the adapter 5 shall be described in detail. The adapter 5 is substantially a pin member and consists of a head portion and a reduced end that is relatively rigid and strong to withstand normal usage of the lock mechanism. A single length of the adapter 5 is applied to two different assembling lengths between the mounting plate 1 and the latch unit 4. As shown in FIG. 4, there is a relatively shorter assembling distance between the mounting plate 1 and the latch unit 4. A single length of the reduced end of the adapter 5 completely extends through the through hole 43 of the latch unit 4. Alternatively, as shown in FIG. 5, there is a relatively longer assembling distance between the mounting plate 1 and the latch unit 4. A single length of the reduced end of the adapter 5 partially extends into the through hole 43 of the latch unit 4.

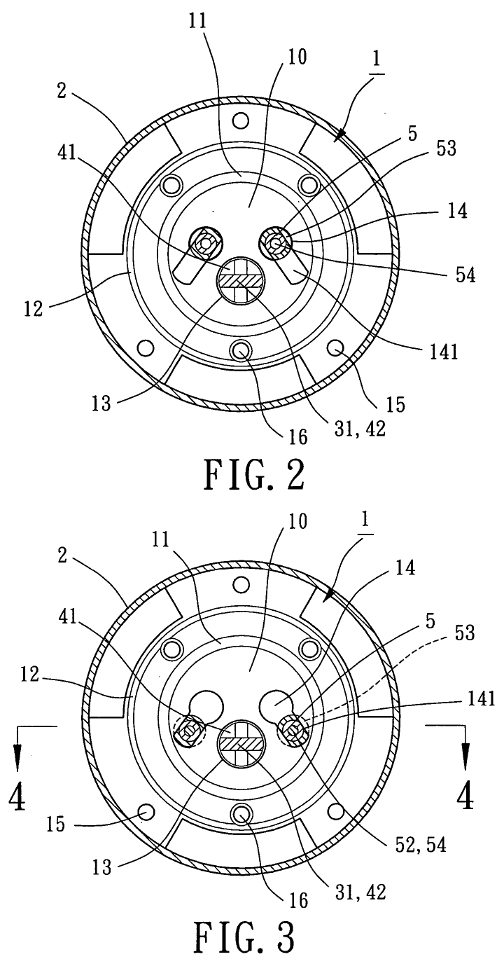

Referring again to FIGS. 2 through 4, when the auxiliary lock mechanism is installed into the assembling bore (38 mm) 61 of the doorplate 6, the first engaging protrusion 11 of the mounting plate 1 initially faces the assembling bore 61 of the doorplate 6. Subsequently, the slit 53 of the adapter 5 snap-connects to the neck portion 141 of the assembling hole 14 of the mounting plate 1. Preferably, the adapter 5 has an end fittingly extending through a through hole 43 of the latch unit 4. When the first engaging protrusion 11 of the mounting plate 1 engaged in the assembling bore 61 of the doorplate 6, the screws 51 extend through the second connecting holes 16 of the mounting plate 1 to fix it on the periphery of the assembling bore 61. The turn button 3 is rotatably combined with the escutcheon rose 2, and the spindle 31 is extended through the lock core hole 21 of the escutcheon rose 2. The screw members 52 are extended through the assembling holes 22 of the escutcheon rose 2, and screw-connected to the screw holes 54 of the adapters 5. Accordingly, the escutcheon rose 2 is mounted to assembling bore 61 of the doorplate 6. Additionally, the spindle 31 of the turn button 3 is inserted into the actuating hole 42 of the actuating cam 41 so as to operate the latch unit 4. In consequence, the screw members 52 mounts the escutcheon rose 2 to the mounting plate 1 while the screws 51 mounting the mounting plate 1 to the doorplate 6.

Referring back to FIG. 5, when the auxiliary lock mechanism is installed into the assembling bore (54 mm) 61′ of the doorplate 6, the second engaging protrusion 12 of the mounting plate 1 alternatively faces the assembling bore 61′ of the doorplate 6. Subsequently, the slit 53 of the adapter 5 snap-connects to the neck portion 141 of the assembling hole 14 of the mounting plate 1. Preferably, the adapter 5 has an end fittingly extending through a through hole 43 of the latch unit 4. When the second engaging protrusion 12 of the mounting plate 1 engaged in the assembling bore 61′ of the doorplate 6, the screws 51 extend through the first connecting holes 15 of the mounting plate 1 to fix it on the periphery of the assembling bore 61′. Similarly, the screw members 52 are extended through the assembling holes 22 of the escutcheon rose 2, and screw-connected to the screw holes 54 of the adapters 5. Accordingly, the escutcheon rose 2 is mounted to assembling bore 61′ of the doorplate 6.

It will be apparent from the aforementioned discussions that the adapter 5 has a single length, thereby simplifying entire assembling operation and saving operational time for mounting the mounting plate 1. Also, the adapter 5 permits employing a relatively shorter length of the screw member 52 that may simplify assembling operation and save operational time for mounting the escutcheon rose 2.

However, the mounting plate disclosed in TWN No. 93204568 requires two different lengths of screw bolts for connecting two different assembling distances between the mounting plate and the latch unit. In comparison with the prior art reference disclosed in TWN No. 93204568, the adapter 5 is provided with the slit 53 fastened on the neck portion 141 of the assembling hole 14 of the mounting plate 1. It can be seen that a single size of the adapter 5 is suitable for two different assembling distances between the mounting plate 1 and the latch unit 4.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A auxiliary lock mechanism comprising:
a mounting plate including a first engaging protrusion on a first side surface and a second engaging protrusion on a second side surface, the first engaging protrusion and the second engaging protrusion are coaxially arranged and selectively engaged in one of two different sizes of assembling bores of a door plate;
at least two assembling holes provided on the first engaging protrusion of the mounting plate;
at least two adapters each having an engaging device fastened on the corresponding assembling hole of the mounting plate, each of the adapters having a first end provided with a screw hole to align with an assembling hole of a escutcheon rose, and a second end engaged with a through hole of a latch unit; and
at least two screw members each of which adapted to extend through the assembling hole of the escutcheon rose and then to fasten with the screw hole of the adapter so that the escutcheon rose is mounted to the mounting plate.

2. The auxiliary lock mechanism as defined in claim 1, wherein the assembling holes of the mounting plate are elongated and each of said assembling holes includes a neck portion on which the engaging device of the adapter is fastened.

3. The auxiliary lock mechanism as defined in claim 1, wherein the assembling holes of the mounting plate are symmetrical with respect to a centerline and extended along two oblique lines.

4. The auxiliary lock mechanism as defined in claim 1, wherein the engaging device of the adapter is a slit fastened on the assembling hole of the mounting plate.

5. The auxiliary lock mechanism as defined in claim 1, wherein a single length of the adapter is applied to a first assembling distance between the mounting plate and the latch unit when the first engaging protrusion of the mounting plate is engaged in a first size of the assembling bore of the doorplate; wherein the single length of the adapter is alternatively applied to a second assembling distance between the mounting plate and the latch unit when the second engaging protrusion of the mounting plate is engaged in a second size of the assembling bore of the doorplate.
